(19) United States
(12) Patent Application Publication
(10) Pub. No.: US 2015/0232165 A1
(43) Pub. Date: Aug. 20, 2015

(54) AIRCRAFT PANEL FOR AN INTERIOR OF AN AIRCRAFT AND METHOD FOR MAKING THE AIRCRAFT PANEL

(71) Applicant: DIEHL AIRCABIN GMBH, Laupheim (DE)

(72) Inventor: Norbert STAUDIGEL, Neu-Ulm (DE)

(73) Assignee: DIEHL AIRCABIN GMBH, Laupheim (DE)

(21) Appl. No.: 14/613,598

(22) Filed: Feb. 4, 2015

(30) Foreign Application Priority Data
Feb. 18, 2014 (DE) 102014002365.6

(51) Int. Cl. B64C 1/06; B32B 3/08; B32B 3/12; B32B 37/18

(52) U.S. Cl. CPC B64C 1/066; B32B 37/18; B32B 3/08; B32B 3/12; B64C 2001/0072

(57) ABSTRACT

Aircraft panel 1 for an interior of an aircraft, wherein the aircraft panel 1 has a sandwich structure 2, wherein the sandwich structure 2 comprises a core section 4 and a covering section 3 as sandwich layers, wherein the covering section 3 comprises a prepreg layer 6 and wherein the aircraft panel 1 comprises at least one switching element 8 for activating at least one electrical device of the aircraft, wherein at least one switching element 8 is fixed in the covering section 3 by the prepreg layer 6.

### BACKGROUND OF THE INVENTION

The invention relates to an aircraft panel for an interior of an aircraft and to a method for making the aircraft panel. The aircraft panel has a sandwich structure, which comprises a core section and a covering section as sandwich layers.

### DISCUSSION OF THE PRIOR ART

Aircraft panels are used in aircraft, for example for lining side walls, floors and/or ceilings of the aircraft. They can also be configured as a constituent part of aircraft internal equipment, for example an overhead stowage compartment. Such an overhead stowage compartment, in which passengers can stow objects and luggage, is normally arranged above passenger seats of the aircraft.

A stowage compartment module for an interior of an aircraft is described, for example, in the laid-open specification DE 10 2007 030 331 A1. The stowage compartment module comprises at least one container and at least one housing to receive the container, at least one passenger supply duct being integrated in the housing. This is configured as a holding device for adjacent components such as cables, pipes, hoses, PSC components, light sources, etc. The container and/or the housing is/are formed from sandwich boards made of a carbon fibre reinforced plastic.

### SUMMARY OF THE INVENTION

The invention is based on the object of providing a functionally improved aircraft panel that can be produced simply.

According to the invention, an aircraft panel for an interior of an aircraft, in particular for an aircraft cabin, is proposed. The aircraft panel is preferably configured, at least in part and/or in sections, as a lining component or equipment component of the aircraft. For example, the aircraft panel can line inner sides of the aircraft. In this function, it can be configured as a floor, ceiling and/or wall lining of the interior of the aircraft. Alternatively or optionally additionally, the aircraft panel can form a constituent part of internal equipment of the aircraft. In particular, the aircraft panel can be configured as a seat lining or as a side wall of an overhead stowage compartment, in particular a so-called pivot bin, of the aircraft.

The aircraft panel has a sandwich structure, which comprises a core section and a covering section as sandwich layers. The covering section preferably has a visible side of the aircraft panel which, in the integrated state in the interior of the aircraft, is visible to the passengers and can be touched. It is preferred for the covering section to cover the core section and/or to be arranged above the core section. Optionally additionally, the sandwich structure comprises a bottom section as a further sandwich layer. In particular, the core section is arranged between the covering section and the bottom section.

The covering section comprises a prepreg layer. Optionally, the prepreg layer is configured as a fibre composite material. The prepreg layer is preferably configured as a semi-finished product made of continuous fibres and an uncured thermosetting plastic matrix. Carbon fibres, alternatively, for example, also glass fibres, basalt fibres or aramid fibres are preferably processed as continuous fibres.

The aircraft panel comprises at least one, in particular electric, switching element which, for example, is configured to activate at least one electrical device of the aircraft, such as an electrical load. For example, the electrical device can be configured as a switch for activating a window blind of the aircraft, in particular a so-called window shade, and/or as a switch for activating an opening mechanism of the overhead stowage compartment, in particular an “automated bin”, and/or for switching a lighting device, in particular a reading light, and so on. Alternatively or optionally additionally, the electrical device can be configured as a control switch, service pushbutton and/or light switch of the aircraft.

The switching element preferably has a switching surface, the mechanical activation of which triggers a switching operation and, as a result, the electrical device can be activated.

The at least one switching element is fixed in the covering section by the prepreg layer. In particular, the prepreg layer forms a fixing layer for the switching element. In particular, the at least one switching element can be arranged in a layer sequence under the prepreg layer, it being possible for the at least one switching element to be covered by at least one layer of the layer sequence, at least in some sections, and in particular to be configured so as to be integrated in the aircraft panel. In particular, in plan view the switching element can either be at least partly covered by the prepreg layer and/or be at least partly covered by a layer or a plurality of layers of the layer sequence, which can be at least partly covered by the prepreg layer. In particular, the at least one switching element can be integrated and/or embedded in the covering section, at least in some sections. The fixing, in particular integration and/or embedding, of the switching element is preferably carried out during production, in particular during pressing or a pressing operation of the sandwich layers to form the sandwich structure of the aircraft panel. Preferably, the aircraft panel is produced in such a way that no subsequent attachment of the at least one switching element to the finished, already pressed, aircraft panel is carried out.

Preferably, the switching surface of the switching element is arranged on the visible side of the aircraft panel and/or the switching surface forms a sub-area of the visible side. In particular, the switching surface is arranged on the visible side such that it is visible and can be touched. Thus, the passengers and/or the aircraft personnel can actuate the switching element simply in order to activate the electrical device.

It is advantageous that, as a result of the integration of the at least one switching element during the production of the aircraft panel, in particular during the pressing of the sandwich structure, otherwise necessary fabrication steps such as milling out a receptacle for the switching element, inserting the switching element into the receptacle and fixing the switching element into the receptacle are dispensed with. As a result, working time and costs arising for this purpose can be saved. Furthermore, it is advantageous that, because of the fixing of the switching element in the covering section by the prepreg layer, a housing for the switching element can be dispensed with. As a result, weight can be reduced and material saved. It is also advantageous that the switching element fixed in the covering section is fully functional and at the same time has positive haptic and optical properties.

The aircraft panel further comprises at least one supporting element for the at least one switching element, the supporting element being configured to hold and to receive the switching element in a supporting manner. For example, the supporting element can be formed from a cured, for example two-layer, phenol synthetic resin prepreg. In particular, the at least one supporting element can be configured as a so-called Airlam material board.

Preferably, the at least one supporting element is configured as a support and/or as a carrier for the at least one switching element. Here, the at least one switching element can preferably be arranged above the supporting element. In particular, it rests on the supporting element, at least partly and/or in some sections. For example, the at least one supporting element has the contour and/or shape of a platelet with a central depression, in particular with a central milled-out section. Around the central depression there can extend an edge region of the platelet that is in particular circumferential, projecting relative to the depression. It is particularly preferred for the at least one switching element to rest on the edge region, in particular projecting with respect to the depression, and/or to be supported on the latter if it is fixed in the covering section by the prepreg layer, in particular in such a way that the region of the switching element that is not in contact is spaced apart from the bottom of the depression. The fact that the switching element rests on the edge region means that it can be pressed into the central depression of the platelet and actuated. In particular, the switching element can be actuated by a compressive or pressing force acting on the switching element in the area of the depression, as a result of which, in particular as a result of pressing a switching surface of the switching element in the direction of the central depression, actuation of the switching element can be brought about, which leads to activation or deactivation of the electrical device of the aircraft. The arrangement of the supporting element as a support and/or carrier with a cavity or clearance formed by the depression underneath the switching element makes it possible for the switching element to give way in the direction of the central depression during the pressing of the sandwich structure during production (curing). As a result, damaging of the switching element by the prepreg layer during the fixing in the covering section can advantageously be avoided.

In a preferred embodiment of the invention, the prepreg layer is spaced apart from the core section and arranged in the direction of the visible side of the aircraft panel. Preferably, the at least one switching element is arranged in a layer sequence underneath the prepreg layer, at least in some sections. In particular, the prepreg layer forms a fixing layer for the at least one switching element.

In a possible implementation of the invention, the aircraft panel comprises a lower prepreg layer. Optionally, the lower prepreg layer makes contact with the core section and/or rests on the latter. In particular, the lower prepreg layer is configured to attach the covering section to the core section. The lower prepreg layer is preferably arranged in the layer sequence between the prepreg layer and the core section. The at least one switching element is preferably arranged in the layer sequence between the prepreg layer and the lower prepreg layer.

It is particularly preferred for the prepreg layer to fix the at least one switching element indirectly or directly in the covering section. Within the scope of the invention, it is possible for the switching element to be covered by the prepreg layer, at least partly and/or in some sections, for the purpose of direct fixing in the covering section. However, it is particularly preferable for the switching element to be connected to the prepreg layer via a further layer of the layer sequence, in particular via a further layer and/or film, in particular by an adhesive film, and thus to be fixed indirectly in the covering section via the said prepreg layer. Particularly preferably, the switching element is covered by the further layer and/or film, and the further layer and/or film is covered by the prepreg layer.

A preferred implementation of the invention provides for the aircraft panel to comprise at least one connecting line for the connection and/or attachment of the at least one switching element with and/or to a power source. For example, the at least one connecting line is configured as a conductor track, in particular made of a copper foil. Preferably, the at least one connecting line is covered by the prepreg layer and, as a result, is fixed in the covering section. In particular, the at least one connecting line runs underneath the prepreg layer. It is also possible for it to be arranged on or above the lower prepreg layer. In particular, the at least one connecting line runs between the lower prepreg layer and the prepreg layer. In particular, the at least one connecting line is inserted during the making of the aircraft panel and subsequently covered with the prepreg layer. For example, the at least one connecting line runs parallel to the core section of the aircraft panel. Thus, the at least one connecting line and the switching element fixed thereto are securely integrated in the covering section.

It is preferable for the at least one connecting line to be electrically conductively connected to the at least one switching device, for example soldered, to form a switching unit. It is particularly preferable for the connecting line to be electrically conductively connected to the switching element to form the switching unit even before the pressing of the sandwich structure. The switching unit is preferably laid on the lower prepreg layer and/or arranged above the latter before the pressing of the sandwich structure. In particular, the lower prepreg layer, the switching unit and the prepreg layer are pressed together in the covering section or to form the covering section.

In a preferred implementation of the invention, the at least one switching element is formed from a metal alloy. The switching element can have diameters in the range of up to 8 mm or 12 mm or even 15 mm. It is particularly advantageous, in particular in this refinement, if the switching element is configured to be relatively flat or shallow. The switching element can preferably have a height of at most 1 mm or of at most 0.7 mm. Such dimensions make it possible to implement a fixing that saves overall space, which in particular can be carried out by means of a prepreg layer in the covering section. In particular, by using such a prepreg layer, comparatively flat integration in the covering section can be carried out. For example, the at least one switching element can be configured as at least one so-called T-switch switch from Nicomatic.

In a preferred refinement of the invention, at least one receptacle for the at least one switching element is introduced into the prepreg layer. The receptacle is configured, for example, as a cut-out in the prepreg layer, which has the shape and size of the switching element and/or is matched to the latter. Preferably, the at least one switching element and optionally additionally the at least one supporting element is/are inserted into the receptacle. In particular, the at least one supporting element is inserted into the receptacle first, the at least one switching element being set in particular on the edge region of the supporting element, so that it is supported on the latter in the receptacle.

A preferred refinement of the invention provides for the covering section to comprise an upper film and/or a lower film. Preferably, the lower film is arranged between the supporting element and the switching element. The supporting element and the switching element can preferably be connected integrally to each other via the lower film, in particular during the production of the aircraft panel. The lower film is preferably configured as a lower adhesive film. For example, the lower adhesive film is configured as an adhesive film or as an adhesive strip. Thus, the supporting element and the switching element can be adhesively bonded to each other, in particular during the production of the aircraft panel.

It is particularly preferable for the upper film to rest on the switching element and to extend beyond the latter. Preferably, the upper film forms the further layer of the layer sequence via which the at least one switching element is preferably connected integrally to the prepreg layer. Preferably, the upper film extends over one or over the switching surface of the switching element. In particular, the upper film is arranged between the prepreg layer and the switching element. The upper film and the prepreg layer preferably overlap in a plan view from above.

The upper film is preferably configured as an upper adhesive film. For example, the upper adhesive film is configured as an adhesive film or as an adhesive strip. Thus, the switching element can be adhesively bonded to the prepreg layer, in particular during the production of the aircraft panel. This effects in particular the indirect fixing of the at least one switching element via the prepreg layer in the covering section.

A preferred constructional implementation of the invention provides for the aircraft panel to comprise a covering film. Preferably, the visible side comprises the covering film and/or the visible side is formed by the covering film. For example, the covering film is configured as a polyvinyl fluoride film. The polyvinyl fluoride film is in particular configured as a transparent film, in particular as a so-called Tedlar film. The covering film preferably extends over the prepreg layer and at the same time over the switching surface of the switching element fixed in the covering section. In particular, the covering film, for example as a decorative and/or protective film, forms a surface of the aircraft panel. Optionally, the covering film serves as an insulation and/or contact protection for the at least one switching element and for the connecting line connected thereto. As a result, safe operation of the at least one switching element in the aircraft panel can advantageously be ensured. Optionally additionally, it is also possible for a lacquer layer, which forms the surface and/or the visible side of the aircraft panel, to be provided additionally on the covering film. By means of the lacquer layer, in particular the visual appearance and/or haptic quality of the aircraft panel can be improved and resistance increased.

In a preferred embodiment of the invention, the core section of the aircraft panel is formed by a honeycomb core and/or the core section comprises the honeycomb core. For example, the honeycomb core is formed from a paper and/or board material. In particular, a coated aramid paper is used for the honeycomb core. This has advantages in particular with regard to a reduced weight of the aircraft panel. The optional bottom section is, for example, formed from a further prepreg layer and/or comprises the latter.

A further possible subject of the invention relates to a method for making the aircraft panel as has been described previously, wherein in one step the at least one switching element is inserted into the covering section and, in a step carried out later, the at least one switching element is fixed indirectly or directly in the covering section via the prepreg layer.

### BRIEF DESCRIPTION OF THE DRAWINGS

Further features, advantages and effects of the invention emerge from the following description of preferred exemplary embodiments of the invention. Here:

FIG. 1 shows a cross section of a basic structure of an aircraft panel having a covering section, a core section and a bottom section, a switching element being fixed in the covering section;

FIG. 2 shows a plan view from above of the switching element from FIG. 1;

FIG. 3 shows a cross section of the switching element from FIG. 1;

FIG. 4 shows a plan view of a visible side of the aircraft panel from FIG. 1 with the switching element fixed in the covering section;

FIG. 5 shows a schematic sequence of a method for making the aircraft panel from FIG. 1.

Mutually corresponding or identical parts are each provided with the same reference symbols in the figures.

### DETAILED DESCRIPTION OF THE INVENTION

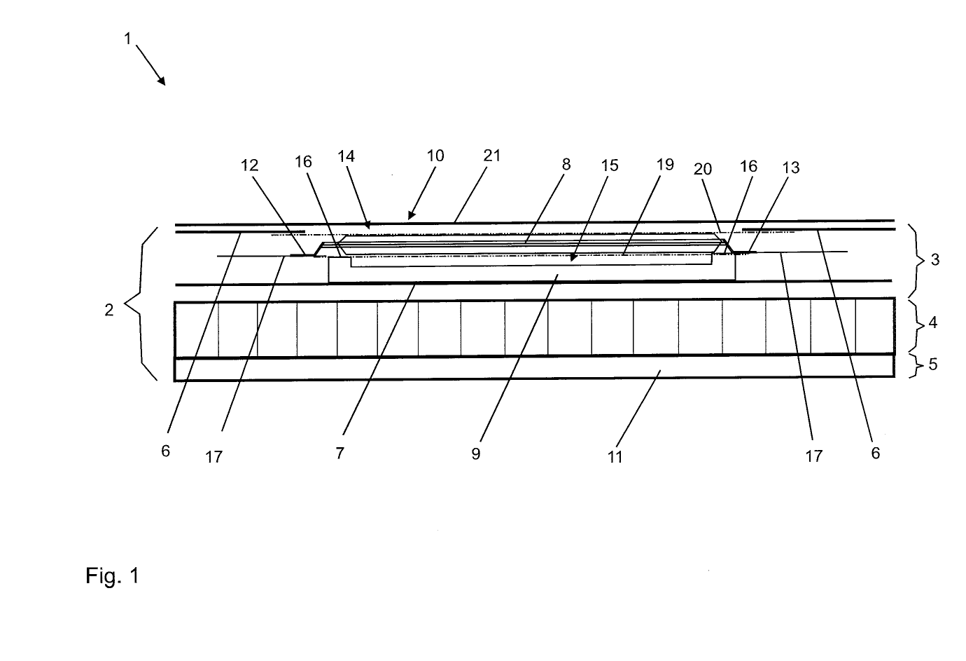

FIG. 1 shows a cross section through an exemplary aircraft panel 1 for an interior of an aircraft, a section line extending parallel to a longitudinal extent of the aircraft panel 1. The aircraft panel 1 is designed as a lining component for lining the interior and/or as an equipment component for equipping an interior construction.

The aircraft panel 1 has a sandwich structure 2, which comprises a covering section 3, a core section 4 and a bottom section 5 as sandwich layers. The core section 4 is arranged between the covering section 3 and the bottom section 5. During the production of the aircraft panel 1, the bottom section 5, the core section 4 and the covering section 3 are laid on one another and pressed with one another to form the sandwich structure 2.

The covering section 3 comprises a prepreg layer 6 and a lower prepreg layer 7, which are configured as a fibre composite material. The bottom section 5 is formed from a fibre composite material, in particular from a further prepreg layer 11. Each of the prepreg layers 6; 7; 11 is configured as a semi-finished product made of continuous fibres and an uncured thermosetting plastic matrix. The core section 4 has a honeycomb core with a multiplicity of honeycombs, which are formed from a paper or board material.

The lower prepreg layer 7 rests on the core section 4 and connects the covering section 3 with the core section 4. The prepreg layer 6 is arranged to be spaced apart from the core section 4 in the direction of a visible side 10 of the aircraft panel 1. In the integrated state of the aircraft panel 1, the visible side 10 is visible and/or can be touched by occupants, as a lining component or equipment component in the aircraft.

The prepreg layer 6 has a receptacle 14 for a switching element 8 of the aircraft panel 1, which is fixed in the covering section 3. The receptacle 14 is configured as a cut-out which, in shape and/or size, resembles the switching element 8 and/or is matched to the latter. In particular, the switching element 8 is arranged in a layer sequence, at least in some sections underneath the prepreg layer 6. The receptacle 14 can also be configured in size or shape such that the same overlaps the switching element 8 in plan view.

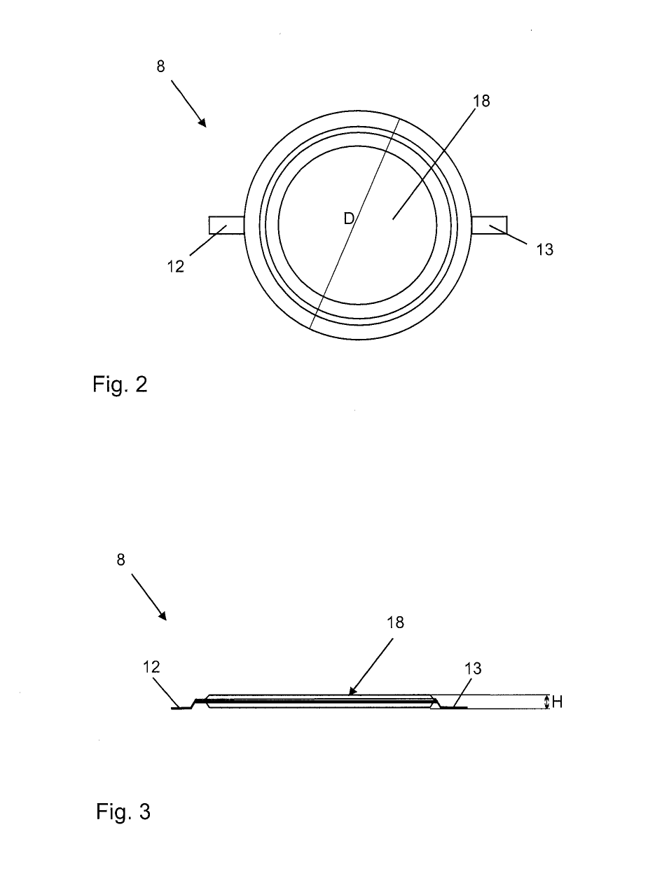

The switching element 8 is shown in FIG. 2 in a plan view from above and in FIG. 3 in cross section. The switching element 8 can be actuated by pressing a switching surface 18. As a result of the actuation of the switching element 8, an electrical device of the aircraft can be activated. The electrical device is, for example, configured as a switch for activating a window blind of the aircraft, in particular a so-called window shade, and/or as a switch for activating an opening mechanism of the overhead stowage compartment, in particular an “automated bin”. Alternatively, the electrical device can also be configured as a control switch, service pushbutton and/or light switch of the aircraft.

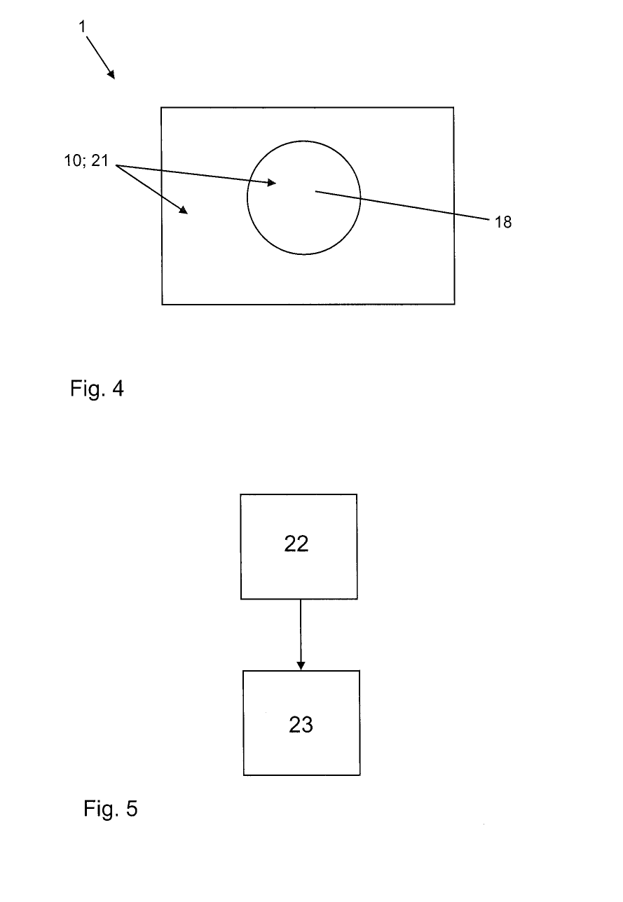

The switching element 8 is, for example, configured as a so-called T switch from Nicomatic. It has a circular outer contour with two laterally projecting contacts 12; 13 for the connection of at least one connecting line 17 (FIG. 1). The switching element 8 can be formed from a metal alloy and, with a diameter D of at most 8 to 15 mm, in particular 8 to 10 mm, has a height H of at most 1 mm, preferably at most 0.7 mm, which is comparatively low in relation to other solutions. In particular, on the basis of the aforementioned external dimensions of the switching element, space-saving integration into the covering section 3 of the aircraft panel 1 can be carried out (see FIGS. 1 and 4).

In order to connect the switching element 8 to a power source of the aircraft, the aircraft panel 1 comprises the at least one electric connecting line 17 (FIG. 1). The latter is formed as a conductor track made of copper wire and is electrically conductively connected to the contacts 12; 13 of the switching element 8, for example soldered to the contacts 12; 13. The connecting line 17 extends underneath the prepreg layer 6 and parallel or substantially parallel to the core section 4.

As illustrated in FIG. 1, the aircraft panel 1, in particular the covering section 3, comprises a supporting element 9 for the switching element 8. The supporting element 9 is arranged in the receptacle 14 on the lower prepreg layer 7. It is configured to mount and/or support the switching element 8. The supporting element 9 is formed from a cured, for example two-layer, phenol synthetic resin prepreg (Airlam material board). It is configured as a platelet having a central depression 15 and a circumferential edge region 16.

The switching element 8 rests with the edge and/or with the contacts 12; 13 on the edge region 16 of the supporting element 9. In particular, the diameters of the supporting element 9 and of the switching element 8 are matched to each other and/or equalized. The switching surface 18 (FIGS. 2 and 3) of the switching element 8 is arranged above the depression 15. As a result, the switching element 8 can be pressed into the central depression 15 without resistance and therefore actuated, so that the electrical device is activated. Furthermore, the aircraft panel 1 can be pressed without difficulty in order to connect the individual sections 3; 4; 5 and to form the sandwich structure 2 without damaging the switching element 8, since the latter can give way into the central depression 15 during the pressing.

The covering section 3 comprises a lower film, which is configured as a lower adhesive film 19. The lower adhesive film 19 is arranged between the supporting element 9 and the switching element 8. It connects the supporting element 9 and the switching element 8 integrally to each other; in particular the supporting element 9 and the switching element 8 are adhesively bonded to each other via the lower adhesive film 19.

The switching element 8 with the connecting line 17 connected thereto is arranged underneath the prepreg layer 6, at least in some sections. For the indirect fixing of the switching element 8 in the covering section 3 by means of the prepreg layer 6, the covering section 3 has an upper film, which is configured as an upper adhesive film 20. The upper adhesive film 20 covers over the switching element 8 and/or extends completely over the latter. It is arranged in the layer sequence between the switching element 8 and the prepreg layer 6, being covered by the prepreg layer 6, at least partly and/or in some sections, and/or overlapping the latter in plan view. By means of the upper adhesive film 20, the switching element 8 is connected integrally to the prepreg layer 6, in particular adhesively bonded to the latter. Thus, the switching element 8 is fixed indirectly in the covering section 3 via the prepreg layer 6.

The aircraft panel 1 has a covering film 21, in particular a polyvinyl fluoride film (so-called Tedlar film), which is arranged on the prepreg layer 6 and forms the visible side 10 of the aircraft panel 1. The covering film 21 is configured for the insulation and/or as contact protection of the switching element 8. Optionally additionally, a lacquer layer can be applied to the covering film 21 in order to improve an optical quality and to protect a surface of the aircraft panel 1.

FIG. 4 shows a plan view of the visible side 10 of the aircraft panel 1. The switching surface 18 of the switching element 8 fixed in the covering section 3 by the prepreg layer 6 is visible and can be actuated by passengers and/or cabin personnel. The visible side 10 is formed by the covering film 21. The covering film 21 extends completely over the prepreg layer 6 and over the switching surface 18 of the aircraft panel 1. Optionally additionally, the lacquer layer can be applied to the covering film 21.

A schematic sequence of a method for making the aircraft panel 1 is shown in FIG. 5. The method comprises the following steps:
22: inserting the at least one switching element 8 into the covering section 3
23: indirectly or directly fixing the at least one switching element 8 in the covering section 3 via the prepreg layer 6.

### LIST OF REFERENCE SYMBOLS

1 Aircraft panel
2 Sandwich structure
3 Covering section
4 Core section
5 Bottom section
6 Prepreg layer
7 Lower prepreg layer
8 Switching element
9 Supporting element
10 Visible side
11 Further prepreg layer
12 First contact
13 Second contact
14 Receptacle
15 Central depression
16 Edge region
17 Connecting line
18 Switching surface
19 Lower adhesive film
20 Upper adhesive film
21 Covering film
22 First method step
23 Second method step
D Diameter
H Height

1. An aircraft panel for an interior of an aircraft, wherein the aircraft panel has a sandwich structure, which comprises a core section and a covering section as sandwich layers, wherein the covering section comprises a prepreg layer, and the aircraft panel comprises at least one switching element for activating at least one electrical device of the aircraft, wherein the at least one switching element is fixed in the covering section by the prepreg layer, and wherein the aircraft panel comprises at least one supporting element for the supportive holding of the switching element in the aircraft panel, wherein the supporting element is configured as a platelet with a central depression and with a circumferential edge region.

2. The aircraft panel according to claim 1, wherein the prepreg layer is spaced apart from the core section and is arranged in the direction of a visible side of the aircraft panel, wherein the at least one switching element is arranged in a layer sequence, at least in some sections, underneath the prepreg layer.

3. The aircraft panel according to claim 2, wherein the aircraft panel comprises a lower prepreg layer, which makes contact with the core section and/or rests on the latter, wherein the at least one switching element is arranged in the layer sequence between the prepreg layer and the lower prepreg layer.

4. The aircraft panel according to claim 1, wherein the at least one switching element is fixed indirectly or directly in the covering section by the prepreg layer.

5. The aircraft panel according to claim 1, wherein the aircraft panel comprises at least one connecting line, which is electrically conductively connected to the at least one switching element, wherein the at least one connecting line is concealed by the prepreg layer and/or embedded in the latter.

6. The aircraft panel according to claim 1, wherein the supporting element rests on the core section in such a way and/or is at least partly pressed into the core section in such a way, wherein the supporting element can in particular be configured and can be connected to the core section in such a way that the switching element is integrated in the aircraft panel in a coplanar manner.

7. The aircraft panel according to claim 6, wherein the switching element rests on the edge region of the at least one supporting element and, at least centrally, can be pressed into the central depression of the at least one supporting element, wherein the switching element can be configured in such a way that an actuation of the switching element can be carried out by pressing into the central depression, and thus the electrical device can be activated.

8. The aircraft panel according to claim 1, wherein the at least one switching element has a maximum height of less than 1 mm.

9. The aircraft panel according to claim 8, wherein the at least one switching element has a maximum height of less than 0.7 mm.

10. The aircraft panel according to claim 6, wherein the prepreg layer has at least one receptacle for the at least one switching element and for the at least one supporting element, wherein the at least one supporting element and the at least one switching element are inserted into the receptacle, wherein the at least one switching element is covered by at least one layer of the layer sequence, at least in some sections.

11. The aircraft panel according to claim 1, wherein the covering section comprises an upper film, wherein the upper film extends between the at least one switching element and the prepreg layer, wherein the at least one switching element is connected integrally to the prepreg layer by the upper film and is fixed in the covering section indirectly via the said prepreg layer.

12. The aircraft panel according to claim 6, wherein the covering section comprises a lower film, wherein the lower film is arranged between the at least one supporting element and the at least one switching element, wherein the at least one switching element is connected integrally to the at least one supporting element by the lower film.

13. The aircraft panel according to claim 1, wherein the aircraft panel has a covering film for the purpose of insulation and/or as contact protection for the at least one switching element, wherein the covering film is arranged on a or on the visible side of the aircraft panel and/or forms the said visible side.

14. The aircraft panel according to claim 1, wherein the core section comprises a honeycomb core and/or is formed by the latter.

15. The aircraft panel according to claim 1, wherein the aircraft panel comprises a bottom section, which has a further prepreg layer or is formed by the latter.

16. A method for making the aircraft panel according to claim 1, comprising:
inserting the at least one switching element into the covering section; and
indirectly or directly fixing the at least one switching element in the covering section via the prepreg layer.
